(19) United States
(12) Patent Application Publication
(10) Pub. No.: US 2005/0077358 A1
(43) Pub. Date: Apr. 14, 2005

(54) System and method for configuring an omnidirectional scanner

(76) Inventors: Thomas Boehm, Medford, NY (US); Morgan Fuchs, Medford, NY (US); Daniel Gonzalez, Setauket, NY (US); Patrick Salatto JR., Miller Place, NY (US); Joel Kahn, Rockville Centre, NY (US); George Lasher, Commack, NY (US); Ed Barkan, Miller Place, NY (US)

Correspondence Address: David M. Carter. Esq.;Carter, DeLuca, Farrell & Schmidt, LLP, Suite 225, 445 Broad Hollow Road, Melville, NY, 11747, US

(21) Appl. No.: 10/681,024

(22) Filed: Oct. 8, 2003

(51) Int. Cl. G06K 7/10; G06K 7/14; G02B 5/00

(52) U.S. Cl. 235/454; 235/462.32

(57) ABSTRACT

An omnidirectional scanning system and method are provided for reading at least one optical code within a field of view of the scanning system and oriented in an orientation included in a set of multiple orientations. The omnidirectional scanning system includes at least one processor for operating the scanning system in at least two modes including a first mode which is a non-restricted omnidirectional scan mode for reading the at least one optical code oriented in any orientation of the set of multiple orientations, and a second mode which is a restricted omnidirectional scan mode for reading the at least one optical code oriented in an orientation of a selectable reduced set of the set of multiple orientations. The method includes the steps of operating the system in a mode selected from the at least two modes including the first mode and the second mode.

### BACKGROUND OF THE INVENTION

1. Field of the Invention

This invention relates to optical scanners for scanning and reading indicia, and in particular to a system and method for configuring an omnidirectional scanner, such as, for example, to read an optical code oriented in one of a plurality of orientations.

2. Description of the Related Art

Various optical code scanner systems have been developed heretofore for reading indicia such as bar code symbols appearing on a label or on a surface of an article.

The symbol itself is a coded pattern of indicia comprised of, for example, a series of bars of various widths spaced apart from one another to bound spaces of various widths, the bars and spaces having different light reflecting characteristics. The scanners in scanning systems electro-optically transform the graphic indicia into electrical signals, which are decoded into alphanumeric characters that are intended to be descriptive of the article or some characteristic thereof. Such characters are typically represented in digital form and utilized as an input to a data processing system for applications in point-of-sale processing, inventory control and the like.

Optical code scanners are used in both fixed and portable installations in many diverse environments, such as in stores for check-out services, in manufacturing locations for work flow and inventory control, and in transport vehicles for tracking package handling. The optical code can be used as a rapid, generalized means of data entry, for example, by scanning a target barcode from a printed listing of many barcodes. In some uses, the optical code scanner is connected to a portable data processing device or a data collection and transmission device. Frequently, the optical code scanner includes a handheld sensor which is manually directed at a target code.

Such optical scanning systems are deployed in handheld units which may be manually pointed at the target. Often an individual scanner is a component of a much larger system including other scanners, computers, cabling, data terminals, etc. Such systems are frequently designed and constructed on the basis of mechanical and optical specifications for the scanning engine, sometimes called “form factors”. One such form factor is the SE1200 form factor designed by Symbol Technologies, Inc.

U.S. Pat. Nos. 4,251,798; 4,369,361; 4,387,297; 4,409,470; 4,760,248; 4,896,026, all of which have been assigned to the same assignee as the instant application, describe laser optical code scanners in which a scanning procedure is performed by emitting a light beam, preferably a laser beam, emitted from a light source, preferably a gas laser or a laser diode, and directing the laser beam to a symbol to be scanned. En route to the symbol, the laser beam is directed to, and reflected by a light reflector of a scanning component. The scanning component moves the reflector for causing the laser beam to scan along a line for scanning the symbol. The scanner is typically able to properly scan the symbol when the symbol is oriented so that the scan line coincides substantially with the symbol. The symbol reflects the laser beam incident thereon. A portion of the incident light that is reflected off of the symbol is collected and detected by a detector component, e.g. a photodiode, of the scanner.

U.S. Pat. Nos. 5,477,043, 5,481,099 and 5,581,070, all of which have been assigned to the same assignee as the instant application, describe omnidirectional scanning systems that generate a scan pattern having multiple scan lines oriented in different directions for scanning in multiple directions, which allows for scanning a symbol regardless of the symbol's orientation relative to the scanner.

Another type of scanner is an array optical imager having an imaging engine which is inherently omnidirectional. The imaging engine includes an image sensor having a two-dimensional array of cells or photo sensors, such as an area charge coupled device (CCD), which correspond to image elements or pixels in a field of view of the imaging engine. The imaging engine further includes a lens assembly for focusing light incident on the image sensor and associated circuitry coupled to the image sensor.

The associated circuitry produces electrical signals corresponding to a two-dimensional array of pixel information for the field of view. The electrical signals are processed by a processor for extracting information indicative of the focus quality of an image corresponding to the field of view. The processing of the electrical signals includes locating the symbol (or symbols) within the array of pixel information, determining the orientation of the symbol(s), extracting the pixel information that corresponds to the symbol(s), and decoding the extracted pixel information. Accordingly, pixel information associated with a symbol that lies within the field of view, regardless of the symbol's orientation relative to the scanner, can be scanned and decoded.

Many applications in which bar scanning is used are not conducive to omnidirectional scanning. In some applications, it is undesirable to decode a symbol that is not oriented in a predetermined direction, and it is undesirable to decode a symbol other than a selected one or more symbols. For example, in an application in which a series of barcodes are provided for individual scanning of one or more barcodes, omnidirectional scanning would interfere with the ability to aim at a selected barcode and scan it so that only the selected one or more barcodes are decoded.

Barcode applications have been developed in which multiple barcodes are provided on one surface, but some of the barcodes are oriented in a vertical orientation while others are oriented in a horizontal orientation, for preventing the user from scanning codes oriented in one of the orientations for improving the ability of a user of a single-line scanner to aim at and scan a selected code. However, an omnidirectional scanner is able to scan in multiple directions, and is capable of scanning codes oriented in either direction, thus defeating the purpose of orienting the codes in multiple orientations. Accordingly, an omnidirectional scanner would not be useful for such applications as described above.

U.S. Pat. No. 6,247,647, which is assigned to the same assignee as the instant application, and which is incorporated herein by reference in its entirety, describes an omnidirectional scanner which is operative for selectively generating an omnidirectional, multiple scan line pattern or a single line scan pattern. The scanner system automatically checks each code scanned for viability for determining if it should be decoded. However, a user may only desire to scan and decode a selected one or more barcodes. The scanner, even while operating in the single-line scan mode, is apt to decode barcodes that the user does not tend to decode, such as barcodes that the scan pattern passes over and scans prior to aiming and scanning a selected barcode.

Furthermore, when operating in the single-line scan mode using scanners according to the prior art, the single-line scan pattern is oriented in a fixed orientation. Furthermore, the scanner operates in either a multi-line scan mode in which all available scan lines are included in the scan pattern or a single-line scan mode.

In accordance with at least the above-mentioned drawbacks of prior art scanners, it is an aspect of the present invention to increase the performance, versatility and reliability of omnidirectional scanners.

Another aspect of the invention is to provide a method and system for enabling a user to select a barcode to be scanned and decoded without scanning and decoding other barcodes in the same field of view when operating an omnidirectional scanner in a single-line scan mode.

It is another aspect of the invention to provide a method and system allowing a user to select the orientation of a single-line scan pattern when operating an omnidirectional scanner in single-line scan mode.

It is a further aspect of the invention to allow a user to select one or more scan lines of an omnidirectional scan pattern of an omnidirectional scanner for scanning optical codes.

### SUMMARY OF THE INVENTION

In one embodiment of the present invention, an omnidirectional scanning system is provided that is capable of reading at least one optical code within a field of view of the scanning system and oriented in an orientation included in a set of multiple orientations is provided. The scanning system includes at least one processor, which includes a means for operating the scanning system in at least two modes including a first mode which is a non-restricted omnidirectional scan mode for reading the at least one optical code oriented in any orientation of the set of multiple orientations, and a second mode which is a restricted omnidirectional scan mode for reading the at least one optical code oriented in an orientation of a selectable reduced set of the set of multiple orientations.

In another embodiment, a method is provided which includes the steps of operating the scanning system in a mode selected from the at least two modes, including the first mode and the second mode, for reading the at least one optical code, and decoding the at least one read optical code.

In still another embodiment, the omnidirectional scanning system further includes one, single position actuator responsive to at least one user action for generating at least one user request signal, and decoder means for decoding sensing signals generated by a sensor sensing the at least one optical code, generating at least one decode signal corresponding to the decoding, and transmitting the at least one decode signal for further processing thereof. The scanning system further includes means for enabling the means for operating the scanning system in a first mode, the means for operating the scanning system in a second mode and the decoder means in accordance with the at least one user request signal. In this embodiment, the reduced set of the set of multiple orientations is predetermined or selectable, and preferably, user-selectable.

In another embodiment, the method for reading the at least one optical code further includes the step of processing at least one user request signal generated in response to at least one user action performed on one, single position actuator and generating at least one user request signal, and decoding sensing signals generated by a sensor sensing the at least one optical code; generating at least one decode signal corresponding to the decoding and transmitting the at least one decode signal for further processing thereof. The method further includes the step of enabling at least one of the decoding, generating and transmitting of the at least one decode signal in accordance with the at least one user request signal. In this embodiment, the reduced set of the set of multiple orientations is predetermined or selectable, and preferably, user-selectable.

In a further embodiment, the scanning system is a two-dimensional imager including a sensor module including at least a two-dimensional optical detector array for sensing light reflected from at least a portion of the at least one optical code and incident on the sensor module, and generating sensing signals corresponding to the sensing. The at least one processor further includes a means for processing the sensing signals. In this embodiment, the reduced set of the set of multiple orientations is predetermined or selectable, and preferably, user-selectable.

In still another embodiment, the method for reading the at least one optical code includes the steps of imaging at least one optical code including sensing light reflected from at least a portion of the at least one optical code with at least a two-dimensional array of photo-detectors, generating sensing signals corresponding to the sensed light reflected from the imaged at least one optical code, and operating the system in a mode selected from the at least two modes including the first mode and the second mode. In this embodiment, the reduced set of the set of multiple orientations is predetermined or selectable, and preferably, user-selectable.

### BRIEF DESCRIPTION OF THE DRAWINGS

Various embodiments of the invention will be described herein below with reference to the figures wherein:

FIG. 1 is a block diagram of an omnidirectional scanning system in accordance with the present invention;

FIG. 2A is a scanning device having the omnidirectional scanning system of FIG. 1;

FIGS. 2B-2I are user input optical codes for programming the omnidirectional scanning system of FIG. 2A;

FIG. 3 is a perspective view of scan line generator included in the scanning device of FIG. 2A in accordance with the present invention;

FIG. 4 is a part-sectional, part diagrammatic view of part of the generator of FIG. 3 and its associated control circuitry;

FIG. 5 is a state diagram of modes of operation of the omnidirectional scanning system of FIG. 1 in accordance with the present invention;

FIG. 6 is a block diagram of an imaging engine for the scanning device of FIG. 2A; and;

FIG. 7 is a block diagram of a processor of the scanning system of FIG. 1.

### DETAILED DESCRIPTION OF THE PREFERRED EMBODIMENTS

The term “read” herein refers to generating a light pattern, sensing reflected light and generating corresponding electrical signals and decoding of the electrical signals. The term “aim” herein refers to generating a light pattern and directing the light pattern at an optical code.

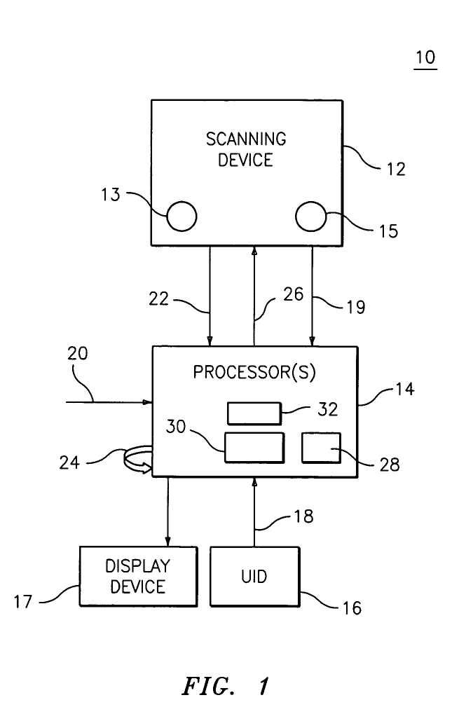

FIG. 1 shows a block diagram of an omnidirectional scanning system 10 for reading an optical code 11. The omnidirectional scanning system 10 includes a scanning device 12, at least one processor 14, and preferably at least one user input device (UID) 16 for receiving user requests and a display 17. The scanning device 12 includes a light source 13, such as at least one light emitting diode (LED) and/or laser source, and a sensor 15, such as at least one photo detector array. During operation of the scanning device 12 at least one light beam emitted by the light source 13 is reflected off of an object that is struck with at least one of the light beams. A portion of the reflected light is sensed by the sensor 15. A field of view of the scanning device 12 is a region in which an object positioned therein would be struck with the at least one light beam, and at least a portion of light from the at least one light beam reflected off of the object would strike the sensor 15. The sensor 15 generates electrical signals (sensing signals) in response to the sensing. The electrical signals are typically processed by electrical circuitry (not shown) for generating corresponding digital signals 19 suitable for processing by the at least one processor 14. The electrical circuitry may be housed within the scanning device 12 or may be located external to the scanning device 12. Furthermore, the light source 13 and the sensor 15 may be housed in different housings.

The at least one processor 14 can execute software modules, including decoder module 28, mode control module 30, and orientation determination module 32. Each module includes a series of programmable instructions executable on the at least one processor 14. The series of programmable instructions can be stored on a computer-readable medium, such as RAM, a hard drive, CD, smart card, 3.5″ diskette, etc., or transmitted via propagated signals for being executed by the at least one processor 14 for performing the functions disclosed herein and to achieve a technical effect in accordance with the invention.

The decoder module 28 decodes the digital signals 19 according to the specific symbology of the optical code and generates a decoded code representation of the data encoded in the optical code, such as a textual code. In known decoding processes, the decoder module 28 is activated upon activation of a scan, upon which the decoder module 28 receives the digital signals 19, and implements an algorithm in software to attempt to decode the digital signals 19.

If sufficient characters, such as start and stop characters and characters between them, corresponding to the scanned optical code were decoded successfully, indicating that a sufficient portion of the optical code 11 was scanned successfully, the decode module 28 generates a successful read signal for providing an indicator of a successful read to the user (such as activation of an indicator light and/or an audible beep), and the decoder module 28 is deactivated. Otherwise, the decoder module 28 receives digital signals 19 corresponding to scanning a next code, and so on, until a successful read, including scan, sense and decode is achieved, or no more codes are available for scanning.

The code representation may be further processed by the at least one processor 14 or other processor(s), such as for display thereof and/or retrieving and/or updating information associated with the decoded code representation, such as a price value and inventory.

The mode control software module 30 receives request signals 18, 20, 22, 24 transmitted by the at least one UID 16 and/or at least one device (e.g., a sensing, scanning and/or timing device) and/or a processor, where the at least one device and/or processor is either included in or not included in at least one of the scanning device 12 or the at least one processor 14, or a combination thereof. The mode control module 30 processes the request signals 18, 20, 22, 24 and generates control signals 26, which it transmits at least to the scanning device 12 and/or the decode module 28 for operating in the selected mode and/or in accordance with selected parameters.

In one embodiment, user request signals 24 are generated by a read operation in which an optical code 11 is read by the scanning system 10, where the optical code 11 (e.g., a barcode) is an input optical code that includes input mode selection(s) and/or parameter selection(s) for “programming” the scanning system 10. The read operation typically includes user activation thereof, and the information read in by the read operation is user entered and includes user requests. Upon reading the optical code the user requests, including mode selection(s) and/or parameter selection(s), are processed by the at least one processor 14 for generating user request signals 24 that instruct the at least one processor 14 to set the mode of operation and parameters in accordance with the input mode selection(s) and/or parameter selections(s).

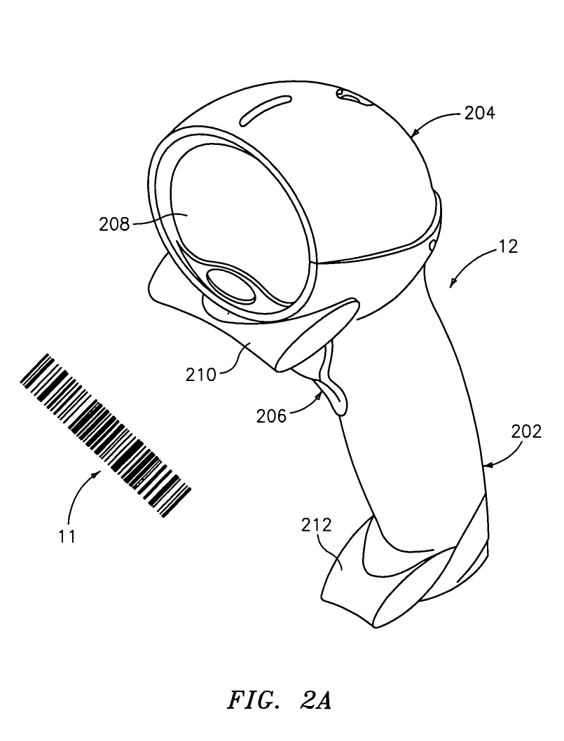

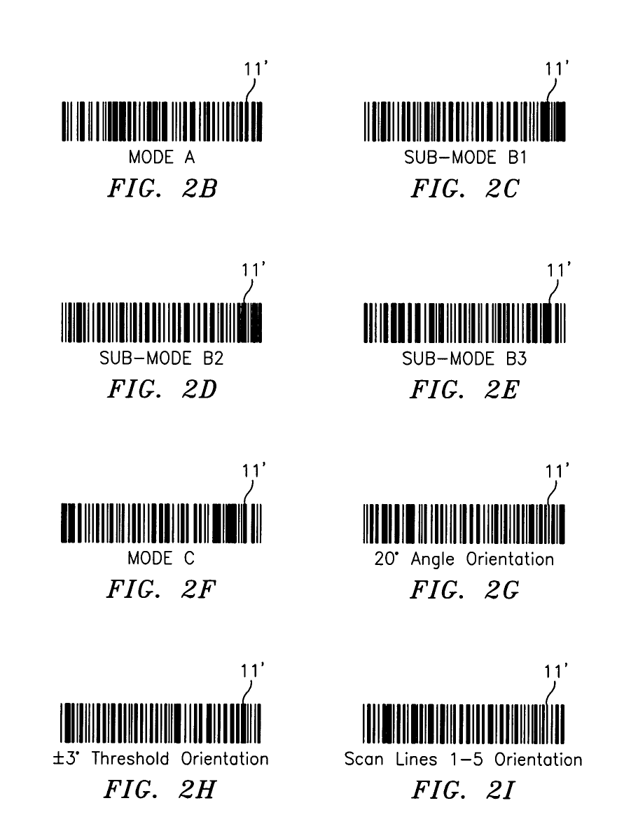

Exemplary input optical codes 11′ are shown in FIGS. 2B-2I. The input optical codes 11′ of FIGS. 2B-2F include input mode selections for selecting modes A, B1, B2, B3 and C, respectively. The modes are described further below. The input optical codes 11′ in FIGS. 2G-2I include input parameter selections for selecting orientation parameters specifying a range, as described further below, including an angle parameter (e.g., 0°), a threshold parameter (e.g., ±0.3°) and scan line selection (e.g., lines 1-5).

The orientation determination module 32 determines the orientation of at least one optical code that was scanned, and designates sensing signals corresponding to optical codes having an orientation within a predetermined range, such as a range selected by a user via the UID 16 or an input optical code 11′, as eligible for further processing, such as decoding.

The request signals 18, 20, 22, 24 include mode selection signals and/or scanning device parameters, including restricted omnidirectional parameters. The mode selection signals control operation of the omnidirectional scanning system 10 for operating in a selected mode of at least modes A and B. When operating in mode A (preferably a default mode), the scanning system 10 operates in a complete omnidirectional scan mode, wherein the scanning system 10 is capable of reading at least one optical code when the at least one optical code is oriented in any orientation of a set of multiple orientations.

When operating in mode B, the scanning system 10 operates in a restricted omnidirectional scan mode, wherein the scanning system 10 is capable of reading the at least one optical code and decoding the corresponding sensing signals when the at least one optical code is oriented in an orientation of a reduced set of the set of multiple orientations. Preferably, the reduced set is defined by a user-selectable orientation parameter.

Preferably, the orientation parameter defines at least one range of angles each defining a range of orientation relative to a predetermined axis, such as the X-axis. For example, the orientation parameter may include at least one angle parameter and associated respective threshold parameters, where each threshold parameter defines the deviation from the associated angle parameter for inclusion in a range of the at least one range of orientation. Preferably, operation in mode B is capable of mimicking operation of a single line barcode scanning system when the orientation parameters are set accordingly. For example, appropriate orientation parameter settings for operation in mode B for achieving mimicking operation of a single line barcode scanning system, include angle parameter=0°, and the associated threshold parameter=±0.2°.

Furthermore, the orientation parameters may have default values that achieve the mimicking of operation of a single line barcode scanning system. Preferably, via the request signals 18, 20, 22, 24, another mode of operation of the scanning system 10, mode C, is selectable. When operating in mode C, the scanning system 10 accepts user input for adjusting scanning device parameters such as volume of an audible beeper for indicating status of a decode process, display control and/or orientation parameters. The mode control module 30 generates control signals 26 in accordance with the selected parameters for controlling scanning of the optical code and/or processing of digital signals 19.

Mode A may include sub-modes including any combination of at least three sub-modes, mode A1, mode A2 and mode A3. When operating in mode A1, control signals 26 are generated for controlling the decoder module 28 to process all digital signals 19 received, so that any optical code scanned is decoded, and transmitted as at least one decode signal for further processing, such as by a host processor which may be external to the scanning device 12 (for inventory, purchase etc., calculations), or a display device. When operating in mode A2, control signals 26 are generated for controlling the decoder module 28 to process all digital signals 19 received until a successful decode is achieved, upon which at least one control signal 26 is generated for disabling the decoder module 28 for preventing the decoder module 28 from decoding and/or transmitting any further decoded information. When operating in mode A3, control signals 26 are generated for disabling the decoder module 28 for allowing the user to aim the scanning device 12 without decoding (including transmission for further processing) any regions scanned.

Mode B may include sub-modes including any combination of at least three sub-modes, mode B1, mode B2 and mode B3. When operating in mode B1, control signals 26 are generated for controlling the decoder module 28 to process all digital signals 19 received, so that any optical code scanned is decoded, and transmitted for further processing, such as by a host processor which may be external to the scanning device 12 (for inventory, purchase etc., calculations), or a display device. When operating in mode B2, control signals 26 are generated for controlling the decoder module 28 to process all digital signals 19 received until a successful decode is achieved, upon which at least one control signal 26 is generated for disabling the decoder module 28 for preventing the decoder form decoding and/or transmitting further decoded information. When operating in mode B3, control signals 26 are generated for disabling the decoder module 28 for allowing the user to aim the scanner without decoding (including transmission for further processing) any regions scanned.

The scanning system 10 is selectively operated in a mode selected from a combination of modes A1, A2, A3, B1, B2, B3 and C. Selection of the mode is achieved by processing by the at least one processor 14, including processing of user requests entered via the UID 16, request signals received from other than the UID 16 and internal conditions. Precedence of mode selection in accordance with user entered requests, other requests and internal conditions is in accordance with design preference.

The UID 16 may be integrated with the scanning device 12 or the at least one processor 14. The UID 16 may include one or more UIDs, integrated with the scanning device 12 and/or the at least one processor 14. In one embodiment, the UID 16 is an actuator or switch, such as a button or trigger, integrated with the scanning device 12. The actuator may be a one, single position or a multiple position actuator. Preferably, the actuator is one, single position trigger, wherein press, release and/or hold actions of the button cause request signals 18 to be transmitted. The UID 16 may include other types of UIDs, such as a keypad, touch pad, touch screen, mouse, joystick, trackball, microphone, etc. The UID 16 may be remote from the at least one processor 14, and may communicate with the at least one processor 14 by wired or wireless communication.

The display 17 preferably is in data communication with the at least one processor 14. The at least one processor 14 provides display data to the display 17 which the display 17 displays, including information regarding selections made by the user, and may further include prompts to the user for prompting the user to make further selections. The display 17 is preferably located proximate the UID 16.

One or more processors included in the at least one processor 14 may be integrated in the scanning device 12 and/or remote from the scanning device 12. One or more processors of the at least one processor 14 may be in data communication (wired or wireless) with one another and/or may operate independently of one another. One or more processors of the at least one processor 14 may be a microprocessor, be included in a network, function as a server, function as a client, and/or be included in a stationary or handheld device other than the scanning device 12, such as PDA or a cellular phone, etc.

The scanning device 12 may be an imaging, laser or other type of scanning device. FIG. 2A shows an exemplary hand-held scanner including a handle 202 for gripping by a user, a body 204 supported by the handle, a trigger 206, either of the single-position or the double-position type, a window 208 through which a light from a light source and/or light reflected from a barcode symbol pass, and a pair of support feet 210, 212 for supporting the scanning device 12 when the scanning device 12 is laid on a countertop or like support surface.

Scanning device 12 is capable of reading barcodes, including stacked, or two dimensional barcodes, such as Code 49, PDF 417 and similar symbologies. It is conceivable that the method and apparatus of the present invention may also find application for use with various machine vision or optical character recognition applications in which information is derived from other types of indicia such as characters or from the surface characteristics of the article being scanned.

Scanning device 12 may be assembled into a very compact package that allows the entire scanning device 12 to be fabricated on a single printed circuit board or as an integral module. Such a module can interchangeably be used as the laser scanning element for a variety of different types of data acquisition systems. For example, the module may alternately be used in a finger ring, hand-held or body-mounted scanner, a table top scanner attached to a flexible arm or mounting extending over the surface of the table or attached to the underside of the table top, or mounted as a subcomponent or subassembly of a more sophisticated data acquisition system. Control or data lines associated with such components may be connected to an electrical connector mounted on the edge or external surface of the module to enable the module to be electrically connected to a mating connector associated with other elements of a data acquisition system.

An individual module may have specific scanning or decoding characteristics associated with it, e.g. operability at a certain working distance, or operability with a specific symbology or printing density. The characteristics may also be defined through software or by the manual setting of control switches associated with the module. The user may also adapt the data acquisition system to scan different types of articles or the system may be adapted for different applications by interchanging modules on the data acquisition system through the use of a simple electrical connector.

The scanning device 12 may also be implemented within a self-contained data acquisition system including one or more such components as a keyboard, display, printer, data storage, application software, and databases. Such a system may also include a communications interface to permit the data acquisition system to communicate with other components of a local area network or with a telephone exchange network, either through a modem or an ISDN interface, by low power radio broadcast from the portable terminal to a portable or stationary receiver or base station. The communication interface may include an infrared data interface (IRDA) or multi-contact shoe for providing communication with an external receiver or docking device, respectively. Data transmitted by the communication interface may include compressed data.

It will be understood that each of the features described above, or two or more together, may find a useful application in other types of scanners differing from the types described herein.

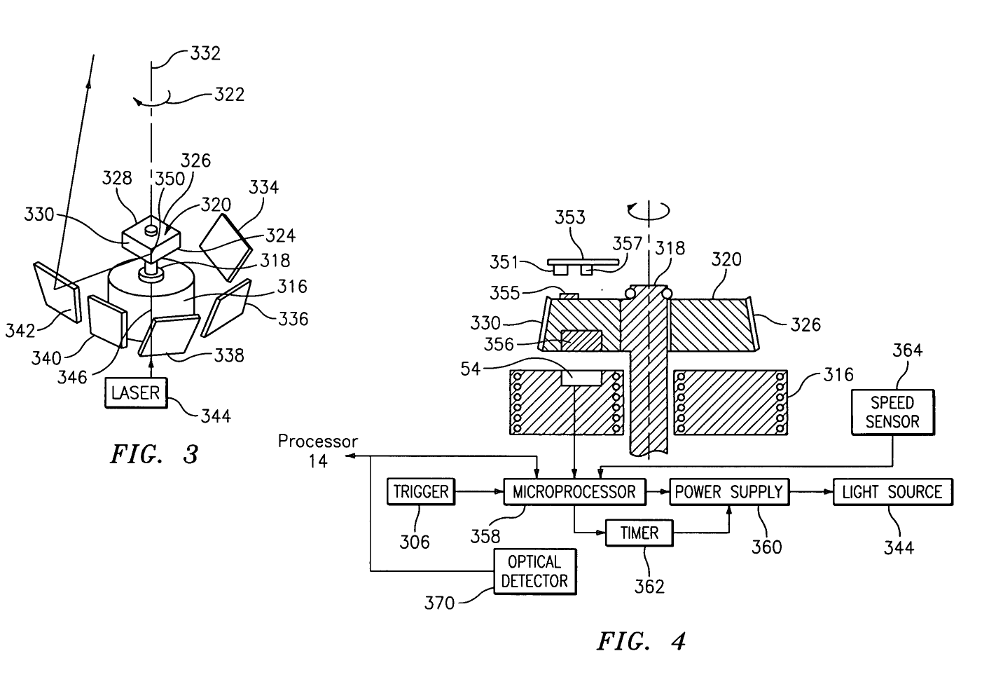

FIGS. 3 and 4 show an exemplary omnidirectional scan pattern generator 300. The configuration shown for generator 300 is illustrative and not limiting. Other omnidirectional scan pattern generator configurations are contemplated.

Generator 300 is included in the scanning device 12 shown in FIGS. 1 and 2, and is capable of generating an omnidirectional scan pattern, including selectively generating a restricted omnidirectional scan pattern in which the scan line(s) generated are selectable. Scanning device 12 may be retrofitted with generator 300 and associated circuitry (not shown) for providing an omnidirectional laser scanner in an omnidirectional laser scanning system. The scan pattern is determined by selection of mode A or B, and when operating in mode B by orientation parameter selection. A single line scan pattern may be generated for mimicking operation of a single line scanning system by selecting an orientation parameter for selecting one scan line, for example, a scan line parallel to the X-axis.

Generator 300 includes a drive motor 316 having an output shaft 318 on which a mirrored element or polygon 320 is mounted for joint rotation in the circumferential direction of the arrow 322 about axis of rotation 332. The element 320 has a plurality of mirrored sides. In the example provided, the element 320 is a cube having four mirrored sides or inner mirrors 324, 326, 328, 330. Each inner mirror 324, 326, 328, 330 is a generally planar, front surface reflecting mirror that is slightly inclined with reference to the x-plane, where an inclination angle of each inner mirror 324, 326, 328, 330 is different. In the embodiment shown, the inner mirrors 324, 326, 328, 330 are of the same size and are equiangularly arranged around the axis 332. It is contemplated that inner mirrors 324, 326, 328, 330 may be formed of various shapes, such as square, rectangular, trapezoidal, oval, etc. and gaps may be provided between the individual mirrors.

The generator 300 further includes a plurality of outer, beam-folding or crown mirrors 334, 336, 338, 340, 342, which are also equiangularly arranged around the axis 332. In the embodiment shown the outer mirrors 334, 336, 338, 340, 342 are arranged partially surrounding the motor 316 in a semi-circular configuration. Any number of outer mirrors 334, 336, 338, 340, 342 may be employed. In the example provided, there are five outer mirrors. Each outer mirror is inclined relative to the x-plane, where the angle of inclination of each outer mirror may be the same. It is contemplated that outer mirrors 334, 336,338, 340, 342 may be formed of various shapes, such as square, rectangular, trapezoidal, oval, etc. and gaps may be provided between the individual mirrors.

A light source 344, preferably a semiconductor laser 334, which corresponds to light source 13 of FIG. 1, is mounted within the scanning device 300 and emits a light beam 346 which is directed to the element 320 for successive reflection off the inner mirrors 324, 326, 328, 330 during rotation of the element 320. Each complete revolution of the element 320 generates, in a preferred embodiment, four inner scan lines in generally mutual parallelism, where the four inner scan lines are distinct due to the different angles of inclination of the inner mirrors 324, 326, 328, 330. The laser beam 336 may be directed through an optical train prior to reaching the element 320, but this has been omitted from FIG. 3 for the sake of clarifying the drawing.

The individual laser beam inner scan lines (four scan lines per rotation) successively reflected off the inner mirrors 324, 326, 328, 330 are, in turn, successively directed to, and reflected from respective mirrors of the outer mirrors 334, 336, 338, 340, 342, and directed through the window 208 (shown in FIG. 2A) toward a barcode symbol to be scanned. It is envisioned that the inner scan lines may be directed through an optical train prior to reaching the outer mirrors 334, 336, 338, 340, 342. Accordingly, each of the four inner scan lines per rotation is reflected off of the five outer mirrors 334, 336, 338, 340, 342, thus generating five intersecting outer scan lines corresponding to each inner scan line, where the intersection of the outer scan lines is due to the different angles of inclination of the respective outer mirrors 334, 336, 338, 340, 342.

In the example provided, there are five intersecting sets of outer scan lines corresponding to each inner scan line of the four inner scan lines, resulting in a total of twenty outer scan lines. The resultant omnidirectional scan pattern provides a very effective coverage over the symbol with a high likelihood that at least one of the twenty outer scan lines will extend across all the bars and spaces of the symbol to be scanned. The omnidirectional scan pattern generated by the exemplary generator 300 is illustrative. Other omnidirectional scan patterns are contemplated.

The omnidirectional scanner further includes an optical detector 370, such as a photo-detector, (which corresponds to sensor 15 of scanning device 12) and associated electrical circuitry (not shown) which are together arranged to detect light reflected off of the optical code being scanned with the outer scan lines. The electrical circuitry typically converts the analog electrical signal generated by the optical detector 370 which correspond to the sensing into a pulse width modulated digital sensing signal, with the widths corresponding to the physical widths of the bars and spaces. The modulated digital sensing signal is processed so that it is suitable for processing by the at least one processor 14. The field of view of the scanning device 12 having generator 300 is the region in which an object positioned therein would be struck with light from the outer scan lines, and at least a portion of the light from the outer scan lines reflected off of the object would strike the photo-detector.

In accordance with this invention, it is desired to convert the omnidirectional scan pattern to a selected restricted omnidirectional scan pattern. When a single line scan pattern is selected it may be useful for mimicking a single line scanning system, for use as an aiming beam or for use as a scanning beam to scan only selected symbol(s). As an aiming beam, the single scan line pattern has sufficient visibility to be seen by the user.

The selected restricted omnidirectional scan pattern is obtained by controlling the scanning process by controlling one or more of the emission of light beam 346 by the light source 344; reflection of the light beam 346 for generating one or more scan lines of the scan pattern; detection of light reflected off of an object being scanned; and/or processing of sensing signals.

In the current example, the selected restricted omnidirectional scan pattern is obtained by reflecting the light beam 346 off of one or more selected inner mirrors 324, 326, 328, 330 in combination with one or more selected outer mirrors 334, 336, 338, 340, 342 in accordance with the orientation parameter, where reflection of the light beam 346 off of the selected combination of mirrors is achieved by controlling emission of the light beam 346 by selectively intermittently operating and de-energizing the light source 344. Alternatively, an aperture of the light source 344 may be controlled for selectively allowing the light beam 346 to be emitted. Accordingly, the orientation parameter actually determines which of the 20 scan lines, and/or portions thereof will be used in the restricted omnidirectional scan pattern. In one embodiment, the user selects the orientation parameter by identifying one or more individual lines (and/or portions thereof) of the 20 scan line pattern to be included in the restricted omnidirectional scan pattern.

In one embodiment, the restricted omnidirectional scan pattern includes two or more parallel scan lines, which may be obtained, for example, by reflecting the light beam 346 off two or more selected inner mirrors of the inner mirrors 324, 326, 328, 330 and one selected outer mirror of the outer mirrors 334, 336, 338, 340, 342. This restricted omnidirectional scan pattern is particularly effective for scanning 2-D codes, such as PDF codes. More specifically, a restricted omnidirectional scan pattern having four parallel scan lines, obtained by reflecting the light beam 346 off of the four inner mirrors 324, 326, 328, 330 and one selected outer mirror of the outer mirrors 334, 336, 338, 340, 342 is particularly effective for scanning 2-D codes, such as PDF codes.

Other methods for generating the restricted omnidirectional scan pattern include providing for and controlling raster control, providing for and controlling rotational movement of the light source 344, moving unselected inner and outer mirrors out of the bath of the light beam 346, providing and controlling blinders on the inner and/or outer mirrors 334, 336, 338, 340, 342, providing and controlling reflective surface of the inner and/or outer mirrors, providing for and controlling operation of motor 316 for controlling rotation of the inner mirrors 324, 326, 328, 330, providing for and controlling rotation of the outer mirrors 334, 336, 338, 340, 342, controlling generation or transmission and/or reception of signals that correspond to sensing of light reflected off an object being scanned; and/or processing of the sensing signals, including decoding thereof.

During operation of the scanning system 10, one or more optical codes located within the field of view of the scanning system are sensed by the optical detector 370. In an embodiment of scanning device 12 configured with a generator 300, as shown in FIGS. 3 and 4, the orientation determination module 32 of processor 14 determines if the sensing signals include sufficient data for processing a barcode such as for decoding thereof.

The orientation determination module 32 allows the sensing signals that include sufficient data, i.e., that correspond to a barcode that was successfully scanned using the selected scan pattern, to be further processed, such as for decoding. However, sensing signals that do not include sufficient data, i.e., that correspond to a barcode that was unsuccessfully scanned using the selected scan pattern, are not further processed, such as for decoding, or alternatively processed for decoding, but results of the decoding are unused, such as for transmission to a host, as display device, etc. Accordingly, the orientation determination module 32 filters out barcodes that are oriented so that the scan line pattern being used does not successfully scan a sufficient portion of the barcode, i.e. barcodes that are oriented with an orientation outside of a selected at least one range.

The intermittent operation of the light source 344 can be achieved in many different ways. In one embodiment, the position of the element 320 on the motor shaft 318 is keyed so that only selected mirror(s) of the inner mirrors 324, 326, 328, 330, and only selected mirror(s) of the outer mirrors 334, 336, 338, 340, 342 are employed to generate the restricted omnidirectional scan pattern. In the present example, the motor shaft 318 is provided, as shown in FIG. 4, with an axial projection or spline 348 that receives, and fits into, a complementary axial groove within the element 320, thereby not only enabling both the shaft 318 and the element 320 to rotate together, but also to determine a fixed angular position that serves as a known reference position from which the position of a leading edge 350 of a selected inner reference mirror, such as inner mirror 330, is determined.

Each scan line of the restricted omnidirectional scan pattern selected in accordance with the orientation parameter is generated by controlling the light source 344 so that the light source 344 is turned for allowing the light beam 346 to reflect off of only selected mirrors of the inner and outer mirrors. The light source 344 is turned on at a first predetermined time interval after the light beam 346 passes the leading edge 350, where the first predetermined time is the time interval needed for a selected inner mirror (determined by the orientation parameter) to be aligned with the light beam 346.

The light source 344 is turned off automatically at a second predetermined time interval after the light beam 346 passes the leading edge 350, where the second predetermined time interval corresponds the amount of time it takes for an unselected inner or outer mirror (determined by the orientation parameter) to be aligned with the light beam 346. This process may be repeated within each revolution for the generation of non-consecutive scan lines, using appropriate time intervals.

After all of the scan lines for the selected restricted omnidirectional scan pattern have been generated for the present revolution the light source 344 is maintained off until the light beam 346 again passes the leading edge 350, and the process is repeated for each revolution. In the embodiment shown, control of light source 344 is provided by timer 362, which may include more than one timer for timing each predetermined interval. It is envisioned that microprocessor 358 may control operation of the light source 344 without the timer 362, such as for directly controlling activation and deactivation of the light source 344.

Preferably, the element 320 is rotated at a given constant speed, such as 4500 rpm ±100 rpm, and completes one revolution accordingly in a known total time. Conditions, such as temperature and/or condition of the motor 316, may affect rotation speed of the element 320. A speed sensor 364 may be provided for sensing the rotation speed and generating a speed sensing signal corresponding to the sensing, which is provided to the microprocessor 358 (that is included in the at least one processor 14, and preferably exchanges information including data and/or control signals with other processing components of the at least one processor 14) and/or a processor external to the generator 300 of the at least one processor 14. A timer 362 is used to automatically shut down the light source 344 by controlling the power supply 360 that supplies power to the light source 344. The timer 362 enables and disables the power supply 360 in accordance with the predetermined time intervals.

The leading edge 350 can be detected by a Hall effect sensor 354 mounted within the motor and cooperating with a magnet 356 mounted in the element 320. Each time the magnet 354 passes the sensor 354, an electrical pulse position signal is generated. This pulse position signal is digitized and provided to microprocessor 358, or other processor of the at the least one processor 14. The microprocessor 358, or other processors or the at least one processor 14, process the speed sensing signal, the position signal and the orientation parameters for generating control signals for controlling generation of the restricted omnidirectional scan pattern.

Rather than using a Hall effect sensor, a light absorbing black stripe 331 can be applied over the leading edge 350. During rotation of the element 320, the moving light beam 346 is swept across the symbol, and light is reflected from the symbol. Some of the reflected light re-enters the scanner through the window 208 and is detected by a system photo detector. The system photo detector generates an analog signal corresponding to the symbol being swept. This analog system is digitized and decoded as is well known in this art. Upon detection by the system photo detector of an abrupt drop in the intensity of the reflected light, the black stripe 331 and the leading edge 330 are reliably detected. As before, the detection of the leading edge is employed to cause the microprocessor 358 to control the laser power supply 360.

Still another way of detecting the leading edge is to mount an auxiliary light source, such as a light emitting diode 351, on a printed circuit board 353 situated above the element 320. A highly reflective dot 355 is applied on an upper surface of the element 320, and is operative to reflect light emitted by the diode 351 to a photodiode 357 located on the circuit board 353 alongside the diode 351. The photo detector 357 detects the presence of the dot 355 and generates an output pulse signal which precisely locates the position of the leading edge 350 during each rotation of the element 320.

Still another technique for locating the leading edge 350 is to use a counter. The counter begins to count at the time that the leading edge passes a known reference point on the shaft, and stops counting at a known time thereafter. The output of the counter is used to control the microprocessor 358 and, in turn, the laser power supply and the laser source.

In a laser scanning system that includes generator 300, the laser scanning system is selectively operated in a mode selected from any combination of modes A1, A2, A3, B1, B2 and B3. In mode A (preferably a default mode), the generator 300 generates a complete omnidirectional scan pattern described above, which is 20 scan lines in the present example. In mode B, the generator 300 generates a restricted omnidirectional scan pattern, where in the present example the restricted omnidirectional scan pattern includes less than the complete omnidirectional scan pattern (i.e., less than 20 scan lines in this example).

In other embodiments of the laser scanner, the combination of modes in which the laser scanning system operates includes additional modes, including mode C in which parameters for the laser scanning system are selected. For example, in sub-mode C1 the orientation parameter is selected, and in sub-mode C2 volume of an audible beeper for indicating status of a decode process is selected.

When in sub-mode C1, the orientation parameter is selected, for example by entering, at least one angle parameter and corresponding threshold parameter(s), or by selecting scan lines, where each scan line of the full set of scan lines is assigned a number ID (1-20, for example). Accordingly, the resultant restricted omnidirectional scan pattern includes the selected scan lines, or scan lines that meet the angle and threshold parameters. Exemplary input optical codes 11′ for entering orientation parameters are shown in FIGS. 2G-2I, where FIG. 2G shows an input optical code 11′ for an angle parameter, FIG. 2H shows an input optical code 11′ for a threshold parameter, and FIG. 2I shows an optical code 11′ for a scan line selection.

As indicated above, the mode of operation of the laser scanning system 10 is selectable by the user. Preferably, the user is capable of selecting the mode of operation from a combination of modes A1, A2, A3, B1, B2 and B3. Preferably, the at least one processor 14 is also capable of selecting the mode of operation in accordance with processing and/or request signals. Precedence of mode selection by the user and the at least one processor 14 is in accordance with scanning system design.

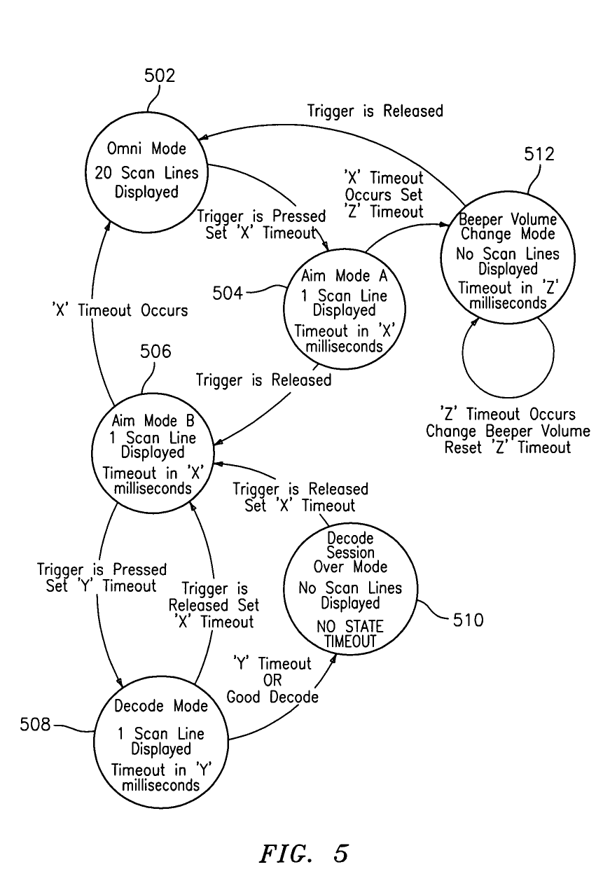

An exemplary state diagram 500 is shown in FIG. 5, including omni mode state 502, aim mode A state 504, aim mode B state 506, decode mode state 508, decode session over mode state 510, and adjust parameter mode 512. Transition between states occurs due to at least one of a user action via the UID 16, as shown in FIG. 1, where the UID 16 is one single position trigger, and the occurrence of a timeout condition. Operation begins in omni mode state 502, in which the laser scanning system 10 generates a full omnidirectional scan pattern. In this example, while in the omni mode, scanned codes are automatically scanned and decoded. It is contemplated that another at least one state be provided, such as a decode mode state selectively transitioned to from omni mode state 502, where the omni mode state 502 is for aiming only and the decode mode state is for decoding.

Upon a user action by the UID 16 (e.g., press a trigger), operation passes to aim mode A state 504 and a timer including at least one timing device is set to timeout in “X” milliseconds. While in the aim mode A state 504, a restricted omnidirectional scan pattern is generated. If a user action by the UID 16 (e.g., release the trigger) is performed before the timer reaches a timeout condition, then operation passes to aim mode B state 506, in which a restricted omnidirectional scan pattern is still generated, and the timer is set again to timeout in “X” milliseconds. Otherwise operation passes to the adjust parameter mode 512 and the timer is set to timeout in “Z” milliseconds.

While in aim mode B state 506, if a user action by the UID 16 (e.g., press of the trigger) is performed before the timer reaches a timeout condition, then operation passes to the decode mode state 508. Otherwise, operation passes to the omni mode state 502. While in decode mode state 508, a restricted onmidirectional scan pattern is generated and the timer is set again to timeout in “Y” milliseconds. If a user action by the UID 16 (e.g., release the trigger) is performed before the timer reaches a timeout condition, then operation passes to the aim mode B state 506. Otherwise, operation passes to the decode session over mode state 510. Furthermore, operation passes to the decode session over mode state 510, upon the occurrence of a successful decode while in decode mode state 508. In the decode session over mode state 510 no scan lines are displayed and no state timeout condition exists. When a user action by the UID 16 (e.g., release the trigger is performed), operation passes to the aim mode B state 506.

When in the adjust parameter mode 512, no scan pattern is generated. In the example provided, the parameter adjusted in the adjust parameter mode is beeper volume, and the adjustment is made by changing the parameter (e.g., volume) a predetermined amount until a timeout condition occurs, upon which the timer is set again to timeout in “Z” milliseconds, for as long as the trigger is held down. It is conceivable that other parameters may be adjusted using the single position trigger and/or using other UIDs. Display 17 preferably indicates to the user which parameter is being adjusted and the status of the parameter.

The orientation parameter entered via the UID 16 is processed by the mode control module 28 for generating control signals 26, such as for controlling the timer 362, which controls the power supply 460, which controls activation of the light source 344, which collectively control scanning of the optical code using the desired restricted omnidirectional scan pattern.

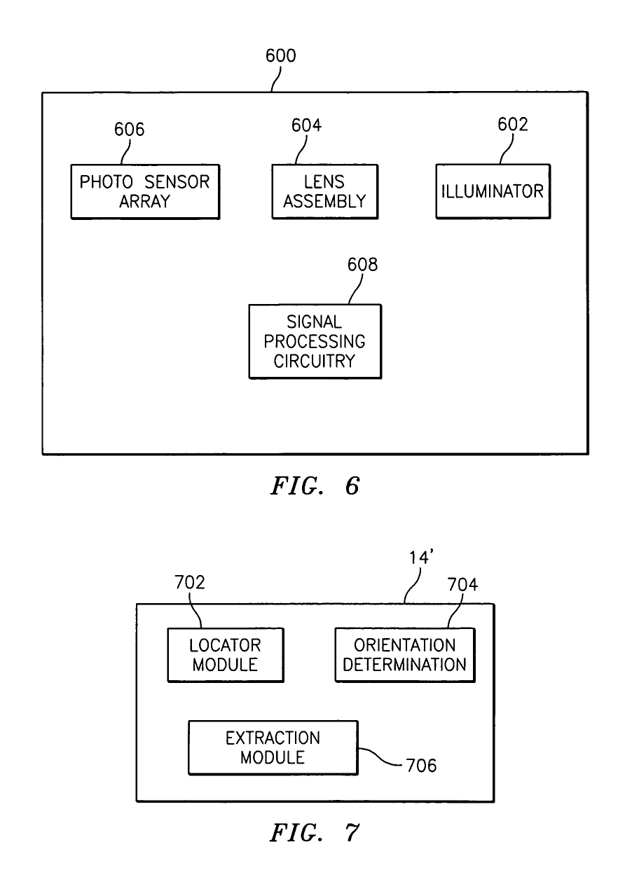

FIG. 6 shows an exemplary imaging engine 600. Imaging engine 600 and associated circuitry (not shown) can be inserted in place of a line scan engine such as generator 300 shown in FIG. 4, and its associated circuitry (not shown) for retrofitting a laser scanning device, such as the device shown by FIG. 2A, with the imaging engine 600 for providing an imager scanning system. In this way, previously designed toolings, housings and host devices may be employed and provide continuity in upgrading the code scanning system. In a preferred embodiment, the imaging engine 600 is less than two cubic inches in volume and is dimensioned to replace a moving laser beam scanning engine in a handheld optical code scanner, such as an SE900 or SE1200 form factor scanning engine.

Imaging engine 600 includes an illuminator 602, corresponding to light source 13 of FIG. 1, for providing illumination during imaging, a two-dimensional photo sensor array 606, corresponding to sensor 15 of FIG. 1, for sensing light entering through window 208 that is incident thereon and generating a corresponding array of pixel signals, i.e., image data, corresponding to the sensed light, a lens assembly 604 having one or more objective lenses for focusing light reflected off of any objects in the field of view of the scanning device and directing the light to be incident on the photo sensor array 606, and signal processing circuitry 608 for processing the pixel signals generated by the photo sensor array 606. All or some of the components of the imaging engine 600 may be included within an integrated circuit board. Furthermore, the signal processing circuitry 608 may be located external to the imaging engine 14 and/or the scanner housing the imaging engine 14.

The illuminator 602 emits a light through window 208 and illuminates the field of view of the scanning device 12 using one or more illumination sources, such as laser LEDs or conventional lighting. The photo sensor array 606 includes a two-dimensional array of cells or photo sensors, such as an area charge coupled (CCD) photo detector, which correspond to image elements or pixels in a field of view of the scanning device 12. Each sensor of the photo sensor array 606 receives a reflected beam via the lens assembly 604 and transmits an analog pixel signal to signal processing circuitry 608.

The signal processing circuitry 608 preferably includes circuitry, such as a buffer, an automatic gain control block, a gain and filter block and a digitizer (not shown) for buffering, amplifying, filtering, and digitizing the pixel signals generated by the photo sensor array 606 to produce digital pixel data suitable for processing by the at least one processor 14 that corresponds to digital signals 19 of FIG. 1. The signal processing circuitry 608 may further include interface circuitry for transmitting digital signals and for interfacing the imaging engine 600 with the at least one processor 14 for direct transmission of the image data to the at least one processor 14 for processing thereof.

The imager scanning device therefore senses light reflected from object(s) located within its entire field of view and provides the corresponding digital pixel data to the at least one processor. Accordingly, the imager scanning device having a two dimensional photo detector array is an inherently omnidirectional scanner, since it will provide digital pixel data corresponding to any optical code located within the field of view of the scanning device regardless of the orientation of the optical code.

The at least one processor responds to request signals selecting the mode of operation of the imager scanning device from a combination of modes A (i.e., A1, A2 and/or A3), B (i.e., B1, B2 and/or B3) and/or C (e.g., C1 and/or C2, etc.), to process the received digital pixel data in accordance with the selected mode, as well as in accordance with selected orientation parameter when operating in mode B. Preferably, mode selection can be performed using one single position trigger for selecting operation in mode A, B or C, including selecting to allow decoding (including transmission for further processing) or to disallow decoding and/or transmission of decoded information for further processing.

When in sub-mode C1, the orientation parameter is selected, for example by entering, at least one angle parameter and corresponding threshold parameter(s) Exemplary input optical codes 11′ for entering orientation parameters are shown in FIGS. 2G-2I, where FIG. 2G shows an input optical code 11′ for an angle parameter, and FIG. 2H shows an input optical code 11′ for a threshold parameter.

As shown in FIG. 7, a processor 14′ (which may include more than one processor) of the at least one processor 14 further includes a locater module 702, an orientation determination 704, and an extraction module 706, which are software modules, each including a series of programmable instructions executable by the at least one processor 14.

The locater module 702 examines the digital pixel data for locating data that corresponds to each optical code scanned. In accordance with design preference and/or mode of operation, the locater module 702 may examine all pixels of the digital pixel data (for example, for locating individual data sets corresponding to respective different optical codes scanned), or examining a series of the digital pixel data (not necessarily sequentially) until a set of data corresponding to a scanned optical code is found.

The orientation determination 704 corresponds to the orientation determination module 32 shown in FIG. 1.The orientation determination module 704 receives the most recent user selected (or default) orientation parameter via a control signal of the at least one control signal 26. Preferably, the user entered orientation parameter includes at least one angle parameter and associated respective threshold parameters indicating an angle relative to a predetermined line, such as the X-axis. Accordingly, together the angle and threshold parameters provide a range of acceptable values.

The orientation determination module 704 determines the orientation for each set of located data relative to a predetermined reference line, such as the X-axis. If the determined orientation is within the range indicated by the orientation parameter, then the located data set is indicated as acceptable for further processing. Otherwise, the located data set is indicated as not acceptable for further processing. If the system is configured for locating and decoding data corresponding to more than one optical code per scan, each data set located is thus processed.

The extraction module 706, for each data set indicated acceptable for further processing, extracts all digital pixel data associated with the data set, i.e. all data corresponding with the respective optical code, and provides the extracted data to the decoder module 28. In another embodiment, extraction is performed for each located data set prior to processing by the orientation determination module 704. In either embodiment, only data sets indicated as acceptable for further processing are decoded.

It will be understood that each of the features described above, or two or more together, may find a useful application in other types of omnidirectional scanning devices differing from the types described above.

The described embodiments of the present invention are intended to be illustrative rather than restrictive, and are not intended to represent every embodiment of the present invention. Various modifications and variations can be made without departing from the spirit or scope of the invention as set forth in the following claims both literally and in equivalents recognized in law.

1. An omnidirectional scanning system capable of reading at least one optical code within a field of view of the scanning system and oriented in an orientation included in a set of multiple orientations, said scanning system comprising:
at least one processor comprising:
means for operating the scanning system in at least two modes, said means for operating comprising:
means for operating the scanning system in a first mode of said at least two modes, wherein said first mode is a non-restricted omnidirectional scan mode for reading the at least one optical code oriented in any orientation of the set of multiple orientations; and
means for operating the scanning system in a second mode of said at least one mode, wherein said second mode is a restricted omnidirectional scan mode for reading the at least one optical code oriented in an orientation of a selectable reduced set of the set of multiple orientations.

2. The scanning system according to claim 1, wherein the scanning system is selected from the group consisting of laser and imager scanning systems.

3. The scanning system according to claim 1, further comprising:
at least one light source illuminating at least a portion of the at least one optical code; and
a sensor module for sensing light reflected from at least a portion of the at least one optical code and incident on the sensor module, and generating sensing signals corresponding to the sensing.

4. The scanning system according to claim 3, wherein the at least one processor further comprises means for decoding the generated sensing signals for decoding the at least one optical code.

5. The scanning system according to claim 4, wherein the means for decoding is selectively enabled via a user request.

6. The scanning system according to claim 5, wherein the means for decoding is selectively enabled in accordance with the user request when the means for operating in the second mode is enabled.

7. The scanning system according to claim 3, further comprising means for generating at least first and second scan line patterns using at least one light beam generated by the at least one light source, wherein the first scan line pattern is generated when the means for operating in the first mode is enabled, and the second line pattern is generated when the means for operating in the second mode is enabled, wherein the first scan line pattern includes a plurality of scan lines and the second scan line pattern includes at least one selected scan line from the plurality of scan lines.

8. The scanning system according to claim 1, wherein the at least one processor further comprises:
orientation determination means for processing sensing signals generated by a sensor that correspond to sensing of the at least one optical code and determining an orientation relative to a predetermined axis of respective sensed optical codes of the at least one optical code;
means for selecting sensing signals that correspond to respective sensed optical codes of the at least one optical code having a determined orientation within a selectable range when the means for operating in the second mode is enabled; and
means for decoding only the selected sensing signals.

9. The scanning system according to claim 1, wherein when operating in the second mode, the scanning system operates as a single line scanning system.

10. The scanning system according to claim 7, further comprising: further comprising:
at least one light source illuminating at least a portion of the at least one optical code;
a control circuit for controlling operation of the at least one light source; and
wherein the at least one processor includes a means for generating a control signal for controlling the control circuit for selectively enabling the at least one light source for generating a selected scan pattern of the first and second scan patterns.

11. The scanning system according to claim 1, wherein the means for operating further comprises means for operating the scanning system in a third mode of the at least two modes; and
wherein the at least one processor processes a user request for adjusting at least one adjustable parameter of the scanning system when the means for operating in the third mode is enabled.

12. The scanning system according to claim 11, wherein the at least one adjustable parameter is selected from the group consisting of intensity of a status indicator and at least one range of angles defining the reduced set of the set of multiple orientations.

13. The scanning system according to claim 11, wherein enablement of the means for operating in the first mode, the means for operating in the second mode and the means for operating in the third mode is in accordance with the received user request.

14. The scanning system according to claim 1, wherein the at least one processor further comprises a means for processing a user input optical code read by the scanning system;
wherein the user input optical code includes at least one input request selected from the group consisting of a mode selection request and a parameter request; and
wherein the means for operating the scanning system operates in a selected mode of the at least two modes in accordance with the processing of the mode selection request, and the reduced set is configured in accordance with the processing of the parameter request.

15. A two-dimensional imager scanning system capable of reading at least one optical code within a field of view of the scanning system and oriented in an orientation included in a set of multiple orientations, said scanning system comprising:
a sensor module including at least a two-dimensional optical detector array for sensing light reflected from at least a portion of the at least one optical code and incident on the sensor module, and generating sensing signals corresponding to the sensing; and
at least one processor comprising:
means for operating the scanning system in at least two modes, said means for operating comprising:
means for operating the scanning system in a first mode of said at least two modes, wherein said first mode is a non-restricted omnidirectional scan mode for reading the at least one optical code oriented in any orientation of the set of multiple orientations;
means for operating the scanning system in a second mode of said at least one mode, wherein said second mode is a restricted omnidirectional scan mode for reading the at least one optical code oriented in an orientation of a predetermined reduced set of the set of multiple orientations; and
means for processing the sensing signals.

16. The scanning system according to claim 15, wherein the orientation of the reduced set is defined by a range of angles relative to a predetermined axis.

17. The scanning system according to claim 15, wherein when operating in the second mode, the scanning system operates as a single line scanning system.

18. The scanning system according to claim 15, wherein the means for operating further comprises means for operating the scanning system in a third mode of the at least two modes; and
wherein the at least one processor processes a user request for adjusting at least one adjustable parameter of the scanning system when the means for operating in the third mode is enabled.

19. The scanning system according to claim 15, wherein the at least one processor further comprises a means for processing a user input optical code read by the scanning system;
wherein the user input optical code includes at least one input request selected from the group consisting of a mode selection request and a parameter request; and
wherein the means for operating the scanning system operates in a selected mode of the at least two modes in accordance with the processing of the mode selection request, and the reduced set is configured in accordance with the processing of the parameter request.

20. The scanning system according to claim 15, the at least one processor further comprising:
orientation determination means for processing respective sensing signals for determining an orientation relative to a predetermined axis of a corresponding optical code of the at least one optical code;
selector means for selecting respective sensing signals wherein the orientation of the optical code corresponding to the selected sensing signals is within a predetermined range; and
decoder means for decoding the sensing signals, wherein when the scanning system operates in the second mode decoding only the selected sensing signals.

21. An omnidirectional scanning system including a scanning device capable of reading at least one optical code within a field of view of the scanning system and oriented in an orientation included in a set of multiple orientations, said scanning system comprising:
one single position actuator responsive to at least one user action for generating at least one user request signal;
at least one processor comprising:
means for operating the scanning system in at least two modes, said means for operating comprising:
means for operating the scanning system in a first mode of said at least two modes, wherein said first mode is a non-restricted omnidirectional scan mode for reading the at least one optical code oriented in any orientation of the set of multiple orientations; and
means for operating the scanning system in a second mode of said at least one mode, wherein said second mode is a restricted omnidirectional scan mode for reading the at least one optical code oriented in an orientation of a predetermined reduced set of the set of multiple orientations;
decoder means for decoding sensing signals generated by a sensor sensing the at least one optical code, generating at least one decode signal corresponding to the decoding, and transmitting the at least one decode signal for further processing thereof; and
means for enabling the means for operating the scanning system in a first mode, the means for operating the scanning system in a second mode and the decoder means in accordance with the at least one user request signal.

22. The scanning system according to claim 21, further comprising means for adjusting system parameters of the scanning system, wherein the means for adjusting system parameters is selectively enabled in accordance with the at least one user request.

23. The scanning system according to claim 22, wherein the system parameter is an orientation parameter for selecting the reduced set of the set of multiple orientations.

24. The scanning system according to claim 21, wherein the decode signal is further processed by at least one of a processor external to the scanning device and a display device of the scanning system.

25. A method for reading at least one optical code within a field of view of the scanning system and oriented in an orientation included in a set of multiple orientations, said method comprising the steps of:
operating the scanning system in a mode selected from at least two modes, including a first mode that is a non-restricted omnidirectional scan mode for reading the at least one optical code oriented in any orientation of the set of multiple orientations, and a second mode that is a restricted omnidirectional scan mode for reading the at least one optical code oriented in an orientation of a selectable reduced set of the set of multiple orientations; and
decoding the at least one read optical code.

26. The method according to claim 25, wherein the decoding step comprises the step of decoding sensing signals generated by a sensor that correspond to sensing of the at least one optical code for generating a decoded digital code.

27. The method according to claim 26, further comprising the step of selectively enabling a decoder for decoding the sensing signals in accordance with a user request.

28. The method according to claim 25, further comprising the steps of:
illuminating at least a portion of the at least one optical code with at least one light source;
generating at least first and second scan line patterns using at least one light beam generated by the at least one light source, wherein the first scan line pattern is generated when operating in the first mode, and the second line pattern is generated when operating in the second mode, wherein the first scan line pattern includes a plurality of scan lines and the second scan line pattern includes at least one selected scan line from the plurality of scan lines.

29. The method according to claim 25, further comprising the steps of:
sensing light reflected from at least a portion of the at least one optical code;
generating sensing signals corresponding to sensing of the at least one optical code;
determining an orientation relative to a predetermined axis of respective sensed optical codes of the at least one optical code;
selecting sensing signals that correspond to respective sensed optical codes of the at least one optical code having a determined orientation within a selectable range when operating in the second mode; and
decoding the selected sensing signals.

30. The method according to claim 28, further comprising the step of controlling operation of the at least one light source for selectively enabling the at least one light source to generate a selected scan pattern of the first and second scan patterns.

31. The method according to claim 25, further comprising the step of selectively operating the scanning system in a third mode for adjusting at least one adjustable parameter of the scanning system in response to a received user request.

32. The method according to claim 31, wherein the at least one adjustable parameter includes at least one range of angles defining the reduced set of the set of multiple orientations.

33. The method according to claim 25, further comprising the step of selecting the mode of operation in accordance with a received user request.

34. The method according to claim 28, wherein the second scan line pattern includes one set of two or more parallel scan lines.

35. A method for reading at least one optical code within a field of view of the scanning system and oriented in an orientation included in a set of multiple orientations, said method comprising the steps of:
imaging the at least one optical code including sensing light reflected from at least a portion of the at least one optical code with at least a two-dimensional array of optical detectors;
generating sensing signals corresponding to the sensed light reflected from the imaged at least one optical code; and
operating the system in a mode selected from at least two modes including a first mode that is a non-restricted omnidirectional scan mode for reading the at least one optical code oriented in any orientation of the set of multiple orientations, and a second mode that is a restricted omnidirectional scan mode for reading the at least one optical code oriented in an orientation of a predetermined reduced set of the set of multiple orientations.

36. The method according to claim 35, further comprising the steps of:
determining an orientation relative to a predetermined axis of respective imaged optical codes of the at least one optical code;
selecting sensing signals that correspond to the respective imaged optical codes of the at least one optical code having a determined orientation within a predetermined range when operating in the second mode; and
decoding the selected sensing signals.

37. The method according to claim 36, further comprising the step of selecting the predetermined range in accordance with a user request.

38. A method for reading at least one optical code within a field of view of the scanning system and oriented in an orientation included in a set of multiple orientations, said method comprising the steps of:
generating at least one user request signal in response to at least one user action performed on a one, single position actuator;
operating the system in a mode selected from at least two modes including a first mode that is a non-restricted omnidirectional scan mode for reading the at least one optical code oriented in any orientation of the set of multiple orientations, and a second mode that is a restricted omnidirectional scan mode for reading the at least one optical code oriented in an orientation of a predetermined reduced set of the set of multiple orientations;
decoding sensing signals generated by a sensor sensing the at least one optical code;
generating at least one decode signal corresponding to the decoding;
transmitting the at least one decode signal for further processing thereof; and
enabling at least one of the decoding, generating and transmitting of the at least one decode signal in accordance with the at least one user request signal.

39. The method according to claim 38, further comprising the steps of:
adjusting at least one system parameter of the scanning system; and
enabling the adjusting in accordance with the at least one user request.

40. The method according to claim 39, wherein the at least one system parameter is an orientation parameter for selecting the reduced set of the set of multiple orientations.
